(19) United States
(12) Patent Application Publication
(10) Pub. No.: US 2017/0336510 A1
(43) Pub. Date: Nov. 23, 2017

(54) Comprehensive, Wide Area Littoral and Land Surveillance (CWALLS)

(71) Applicant: Irvine Sensors Corporation, Costa Mesa, CA (US)

(72) Inventors: James Justice, Newport Beach, CA (US); Medhat Azzazy, Laguna Niguel, CA (US)

(73) Assignee: Irvine Sensors Corporation, Costa Mesa, CA (US)

(21) Appl. No.: 15/459,642

(22) Filed: Mar. 15, 2017

Related U.S. Application Data
(60) Provisional application No. 62/310,035, filed on Mar. 18, 2016.

(51) Int. Cl. G01S 17/87; G01S 17/46; G01C 13/00; G01S 17/02; G01S 17/89; G01S 17/58

(52) U.S. Cl. CPC G01S 17/87; G01S 17/89; G01S 17/58; G01C 13/00; G01S 17/023; G01S 17/46

(57) ABSTRACT

The LIDAR apparatus disclosed in this application provides a capability, when deployed on airborne platforms, to increase area search rates to over 1000 square kilometers per hour which is an increase of over a factor of 100 better than the current state of the art. This apparatus operates in the SWIR and Blue-green spectral bands and provides a capability to detect and recognize small objects on the land and sea surface and below the sea surface.

### CROSS-REFERENCE TO RELATED APPLICATIONS

This application claims the benefit of U.S. Provisional Patent Application No. 62/310,035, filed on Mar. 18, 2016 entitled “Comprehensive, Wide Area Littoral and Land Surveillance (CWALLS)” pursuant to 35 USC 119, which application is incorporated fully herein by reference.

### STATEMENT REGARDING FEDERALLY SPONSORED RESEARCH AND DEVELOPMENT

N/A.

### BACKGROUND OF THE INVENTION

### 1. Field of the Invention

The invention relates generally to the field of three dimensional imaging LIDARS. More specifically, the invention relates to a method and apparatus for performing wide area search by a LIDAR system simultaneously containing two types of LIDAR sensing modes. The first mode is designed to perform wide area surveillance of land and sea surface areas from air vehicles. The objective of this mode of operation is to provide a major increase in the area search rates that can be performed by LIDARS enabling detection and classification of surface targets. The second mode is designed to provide a major increase in the area search rates available from LIDARS for wide area surveillance of underwater zones enabling detection and classification of undersea vehicles and objects located near the surface.

### 2. Description of the Prior Art

Airborne LIDAR search systems today are designed for single mission objectives evolving around land surface surveillance, sea surface surveillance, and undersea surveillance. Each LIDAR system uses an appropriate detector selection to optimize LIDAR sensor system characteristics for the particular mission. Land surveillance and sea surface LIDARS operate, typically, in 0.9 of 1.05 micron spectral bands determined by the lasers used for the scene illumination. Area search rates are limited by the detector sensitivities, focal plane array sizes, the read-out electronic circuits which determine the numbers of scene elements that can be observed in a specified time. Typical state of the art systems used for surface mapping employ a scanner which illuminates a very small region of a scene to be mapped at a time and then scans out larger scenes requiring many laser shots which have signal pulse energies in the 10s of micro-joules. This type of laser which provides low pulse energy but very high pulse rate fundamentally limits the ranges and area search rates at which highly accurate surface surveillance is achieved The LEIKA ALS80 is the state of the art in this type of LIDAR. An additional type of laser that is used for surface surveillance employs a low pulse rate but a higher energy per pulse. State of the art of this type of laser is represented by the Arête Associates A-TID-1064 laser system. Its characteristic likewise limit is area search rate due to the factors enumerated above. Undersea surveillance LIDARS, which typically operate in the spectral region at 0.53 microns, require considerable energy for penetration of even shallow depths of sea water to detect vehicles and objects there. This factor further limits area search rate. The need to have different types of LIDARS to accomplish the wide area search functions desired to be performance from Air Vehicles results in complex, costly solutions.

What is needed is a type of LIDAR sensor system that will enable simultaneous wide area surveillance of land and sea surface areas and wide area undersea areas to be conducted with the same LIDAR sensor system. Further, the LIDAR systems should operate in conditions when visibility is impaired by environmental factors such as fog, dust or haze. The area search rates of current systems need to be increased by a factor of 10 to achieve highly effective performance. The multi-mode LIDAR system disclosed herein is such a system.

### BRIEF SUMMARY OF THE INVENTION

The LIDAR apparatus disclosed herein enables a very large increase in the area that can be searched by airborne platforms carrying the LIDAR system. This increase in area search capability is achieved while providing sufficient high spatial resolution and high, near photon counting sensitivity to detect and recognize small objects on the land and sea surface as well as detecting small objects under the sea surface to a depth of about 100 meters. This advance in the state of the art of wide area search LIDARS is enabled by the use of many (thousands) of very small (less than 15 micrometers) detectors in a linear array. This array of thousands of detectors is mechanically swept over wide swaths beneath the airborne platforms carrying the instrument. Laser devices are incorporated that provide optimum capabilities in clear and degraded visual atmospheric conditions surface surveillance as well as a capability to see at some depth in water. Two lasers of optimum wavelength are incorporated in the apparatus.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 presents the Operating Concept of the C-WALLS LIDAR System Concept.

FIG. 2 presents an exemplar design of the multi-mode C-WALLS System Concept.

FIG. 3 provides the design and features of the high sensitivity, high resolution, large format focal plane array and integrated read-out concept that enables the C-WALLS exceptional area search rate and target detection and classification capability.

The invention and its various embodiments can now be better understood by turning to the following description of the preferred embodiments which are presented as illustrated examples of the invention in any subsequent claims in any application claiming priority to this application. It is expressly understood that the invention as defined by such claims may be broader than the illustrated embodiments described below.

### DETAILED DESCRIPTION OF THE INVENTION

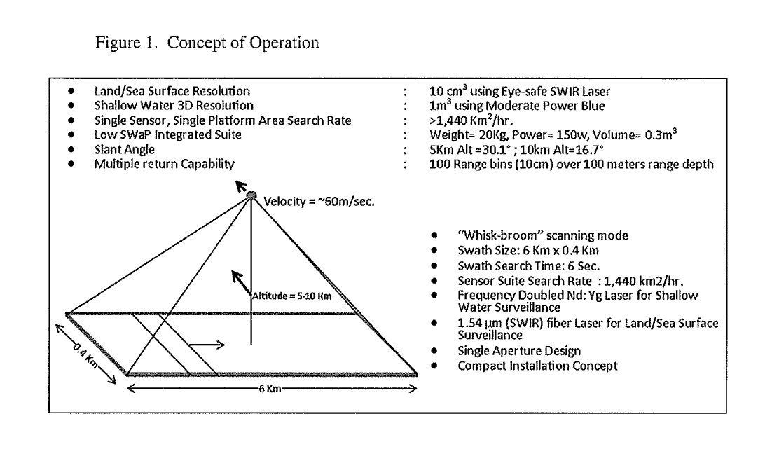

The C-WALLS LIDAR system operates from air vehicles by using a very long detector array (>4000 detectors) aligned with the track direction of the vehicle that sweeps the scene below the air vehicle in a cross-track manner. The deep depth of the coverage in the track direction creates a large swath of coverage deep enough that by the time the sweep repeats it is covering additional part of the scene. Further the very large numbers of detectors in the receiver simultaneously sample the scene at very high resolution, typically with a 10 cm ground sample distance for surface surveillance and 1 m for undersea surveillance. This combination of very large numbers of detectors in the track direction and the wide sweep executed in the cross-track direction creates an area search greater than 1000 square km per hour—a factor of 100 greater that current state of the art LIDARS performing similar search functions at this resolution. This operations concept is illustrated in FIG. 1.

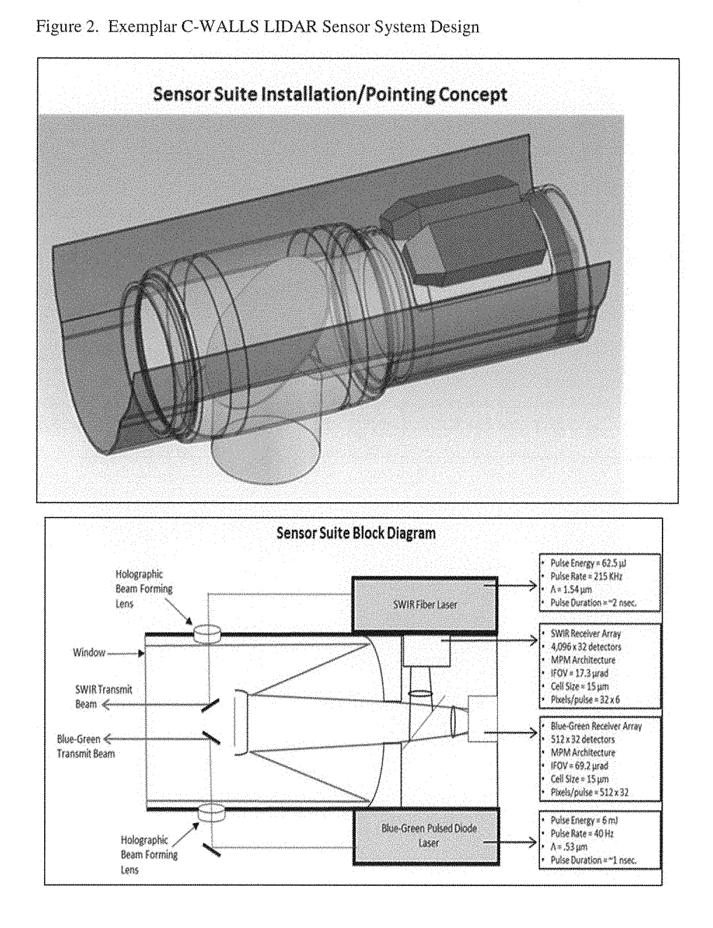

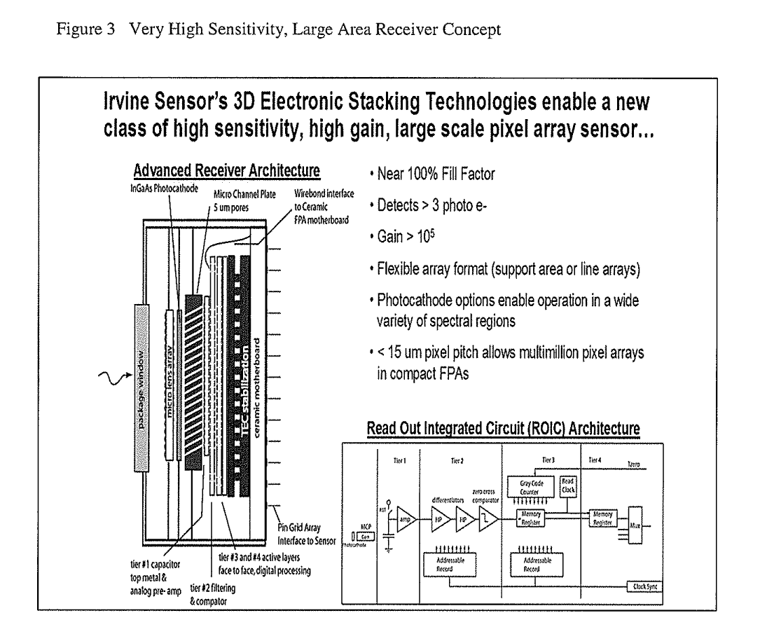

The disclosed method and apparatus for the Comprehensive Wide Area Littoral and Land Surveillance LIDAR system has several key characteristics. 1) The multi-mode LIDAR employs two lasers which can be operated sequentially or simultaneously. The first laser operates at the eye safe wavelength of 1.5 microns which additionally provides good performance under conditions of degraded visual environments caused by rain, dust, or haze. This is a high pulse rate, low pulse energy fiber laser. This laser supports the land and sea surface wide area surveillance search mode. The second laser operates at the wavelength of 0.53 microns which provides good penetrate of water. This is a diode pumped laser with low repetition rate but high energy per pulse characteristics. This laser supports the undersea wide area surveillance search mode. The layout of the exemplar design showing the two channels of operation is presented in FIG. 2. 2) The advanced focal plane array concept with its integrated readout circuits is illustrated in FIG. 3. This is a key enabler of C-WALLS high search rates since each of the many detector elements is capable of near photon counting sensitivity while exhibiting a very high dynamic range in a very small pixel size which enable compact focal plane arrays with thousands of detectors in its line array. No other LIDAR focal plane technology has this combination of features. The advanced receiver array consists of a photocathode, microchannel plate, and integrated three dimensional electronic read out circuits. Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by any claims in any subsequent application claiming priority to this application.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A LIDAR apparatus which provides high area search rates while maintaining high spatial resolution and high sensitivity enabling detection and recognition of small objects while performing the wide area search function.

2. The LIDAR apparatus of claim 1 may contain a linear array of several thousand detectors.

3. The LIDAR apparatus of claim 1 may contain an array of very small detectors with near photon counting sensitivity.

4. The LIDAR apparatus of claim 1 may contain a laser that operates in the Short Wavelength Infrared spectral region.

5. The LIDAR apparatus of claim 1 may contain a laser that operates in the Blue-Green spectral part of the visible light spectrum.

5. The LIDAR apparatus of claim 1 may contain a wide field of view optical system that transmits and receives the various laser wavelengths of the lasers contained with the apparatus.

6. The LIDAR apparatus of claim 1 may contain mechanical elements that point that transmit and receive optical elements in the wide swath pattern executed to achieve the area search functions.

7. The LIDAR apparatus of claim 1 may contain signal processing elements that use time of flight techniques to determine the precise range to elements viewed by the apparatus.
